(19) United States
(12) Patent Application Publication
(10) Pub. No.: US 2024/0400747 A1
(43) Pub. Date: Dec. 5, 2024

(54) WATERBORNE SILICONE ACRYLIC RESIN SYSTEMS AND COATINGS

(71) Applicant: SWIMC LLC, Cleveland, OH (US)

(72) Inventors: Hong DING, Hudson, OH (US); Milena Maria GARAY-TOVAR, Mantua, OH (US); Heidi Marie PAVLOSKY, Rocky River, OH (US)

(21) Appl. No.: 18/689,535

(22) PCT Filed: Sep. 22, 2022
(86) PCT No.: PCT/US2022/076845

§ 371 Date: Mar. 6, 2024

Related U.S. Application Data
(60) Provisional application No. 63/261,580, filed on Sep. 24, 2021.

(51) Int. Cl. C08G 18/62; C08K 9/08; C09D 5/02; C09D 7/42; C09D 175/12

(52) U.S. Cl. CPC C08G 18/6295; C08K 9/08; C09D 5/022; C09D 7/42; C09D 175/12; C08G 2150/00

(57) ABSTRACT

The present application relates to a waterborne polymer system suitable for two-component polyurethane coating applications. Provided herein is a waterborne polymer system comprising: 1) a silicone-modified acrylic emulsion comprising: about 1% to about 30% by weight silicone based on resin solids; and at least one hydroxyl functional acrylic monomer; and 2) at least one secondary binder comprising at least one acrylic emulsion, at least one water-reducible polyester polyol, at least one polyurethane dispersion, or combinations thereof; wherein the silicone-modified acrylic emulsion has a Tg of about −50° C. to about 20° C.; and wherein a hydroxyl equivalent weight (OH EW) of the silicone-modified acrylic emulsion is about 400 g solid/mol or less. A waterborne coating is also disclosed comprising the waterborne polymer system described herein. These waterborne polymer system and two-component water-borne coating compositions including the silicone-modified acrylic emulsion are capable of achieving high chemical resistance, strong adhesion, especially after weathering, and excellent scratch and mar resistance at low gloss.

### FIELD

The present disclosure relates generally to compositions for a binder, and, more particularly, a waterborne polymer system comprising: 1) a silicone-modified acrylic emulsion comprising: about 1% to about 30% by weight silicone based on resin solids; and at least one hydroxyl functional acrylic monomer; and 2) at least one secondary binder comprising at least one acrylic emulsion, at least one water-reducible polyester polyol, at least one polyurethane dispersion, or combinations thereof; wherein the silicone-modified acrylic emulsion has a Tg of about −50° C. to about 20° C.; and wherein a hydroxyl equivalent weight (OH EW) of the silicone-modified acrylic emulsion is about 400 g solid/mol or less. Further, the silicone-modified acrylic emulsion comprises substantially no surfactant. A waterborne coating is also disclosed comprising the waterborne polymer system is described herein as well as an article comprising the waterborne coating.

### BACKGROUND

More recently, conventional 2K waterborne polyurethane coatings with water-based acrylic and/or polyester polyols and/or polyurethane dispersion have been used in numerous applications, including but not limited to applications over plastics. However, these types of coatings cannot pass several opposing performance requirements simultaneously, especially when the coatings must achieve lower gloss or matte specifications at a lower dry film thickness. “Lower gloss coatings” or “matte coatings” include those with a gloss of about 4 or less for a 60-degree reading. “Lower gloss coatings” or “matte coatings” may also be referred to as coatings with a very low gloss. “Lower dry film thicknesses” may be generally those of about 1 mil, but may include thicknesses of 3 mil or less.

Performance requirements for these conventional 2K waterborne polyurethane coatings may include but are not limited to adhesion, chemical resistance, scratch resistance, mar resistance, abrasion resistance, surface slip, recoatability, weathering, wear resistance, and other testing. The coatings should also be free of surface defects like craters and have excellent adhesion to rigid plastic substrates after xenon exposure. Although certain properties may improve with changes to the polyurethane and the coatings formulation, others may suffer due to these modifications. Further, conventional waterborne polyurethane coatings do not perform as well as solvent-borne polyurethane coatings with respect to these performance requirements, especially for chemical resistance, mar resistance, wear resistance, and adhesion.

Manufacturers, especially wood, plastics, electronics, automotive, aerospace, marine, general industrial, and other consumer goods manufacturers, have increasingly demanded for these particular performance requirements for coatings. Manufacturers are continually looking for coatings that exhibit these improved properties, such as chemical resistance, wear resistance, and adhesion, while having a lower gloss and film thickness without sacrificing other performance properties, such as scratch and abrasion resistance. In view of these challenges with many conventional 2K polyurethane binders, the need therefore remains for improved waterborne coatings having a binder that can provide adhesion, chemical resistance, scratch resistance, abrasion resistance, surface slip, recoatability, weather resistance, and other improved properties as well as other advantages. Additionally, there is also a need to provide improved waterborne coatings that substantially perform as well as solvent-borne polyurethane coatings.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A waterborne polymer system and methods of preparing are shown and described. The waterborne polymer system may comprise: 1) a silicone-modified acrylic emulsion comprising: about 1% to about 30% by weight silicone based on resin solids; and at least one hydroxyl functional acrylic monomer; and 2) at least one secondary binder comprising at least one acrylic emulsion, at least one water-reducible polyester polyol, at least one polyurethane dispersion, or combinations thereof; wherein the silicone-modified acrylic emulsion has a Tg of about −50° C. to about 20° C.; and wherein a hydroxyl equivalent weight (OH EW) of the silicone-modified acrylic emulsion is about 400 g solid/mol or less. In some embodiments, the silicone of the silicone-modified acrylic emulsion may be a (meth)acryl-modified silicone fluid. In another embodiment, the (meth)acryl-modified silicone fluid of the silicone-modified acrylic emulsion may be a mono(meth)acryloxypropyl terminated polydimethylsiloxane.

Further, the silicone-modified acrylic emulsion may have an acid value of about 10 mg KOH/g to about 30 mg KOH/g. Additionally, the silicone-modified acrylic emulsion may have a Tg of about −40° C. to about 0° C.

A waterborne coating is also disclosed comprising the waterborne polymer system described herein. A method of making the waterborne polymer system is also described herein.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

### Waterborne Binder

The present disclosure relates generally to binders that provide advantageous improvements over current binders. It has been discovered that the use of a particular waterborne polymer system comprising: 1) a silicone-modified acrylic emulsion comprising: about 1% to about 30% by weight silicone based on resin solids; and at least one hydroxyl functional acrylic monomer; and 2) at least one secondary binder comprising at least one acrylic emulsion, at least one water-reducible polyester polyol, at least one polyurethane dispersion, or combinations thereof; wherein the silicone-modified acrylic emulsion has a Tg of about −50° C. to about 20° C.; and wherein a hydroxyl equivalent weight (OH EW) of the silicone-modified acrylic emulsion is about 400 g solid/mol or less can surprisingly lead to improved performance properties when used in a coating, namely improved adhesion, chemical resistance, scratch resistance, abrasion resistance, surface slip, recoatability, and weathering resistance, as well as other advantages.

Typically, binders with hydroxyl equivalent weight (OH EW) of 630 g/mol or less; are used in coatings, especially coatings for plastics. However, the use of binders comprising silicone-modified acrylic binders and at least one hydroxyl functional acrylic monomer with a hydroxyl equivalent weight (OH EW) of the silicone-modified acrylic emulsion of about 400 g solid/mol or less surprisingly and advantageously provide these improved performance properties like improved adhesion, chemical resistance, scratch resistance, abrasion resistance, surface slip, recoatability, weathering resistance, and others.

In many embodiments, a waterborne polymer system may comprise: 1) a silicone-modified acrylic emulsion comprising: about 1% to about 30% by weight silicone based on resin solids; and at least one hydroxyl functional acrylic monomer; and 2) at least one secondary binder comprising at least one acrylic emulsion, at least one water-reducible polyester polyol, at least one polyurethane dispersion, or combinations thereof; wherein the silicone-modified acrylic emulsion has a Tg of about −50° C. to about 20° C.; and wherein a hydroxyl equivalent weight (OH EW) of the silicone-modified acrylic emulsion is about 400 g solid/mol or less. The silicone-modified acrylic emulsion may have a hydroxyl equivalent weight (OH EW) of about 400 g solid/mol or less. The Tg described herein is measured by Differential Scanning calorimetry (DSC) using ASTM D6604-00. The hydroxyl value is determined using ASTM E222-65T. The hydroxyl equivalent weight (OH EW) is calculated by 56100 being divided by the hydroxyl value:

$$Equivalent weight ( g / equivalent ) = - \frac{56100}{Hydroxyl value}$$

In some embodiments, the silicone of the silicone-modified acrylic emulsion is a (meth)acryl-modified silicone fluid. In one embodiment, the (meth)acryl-modified silicone is a mono(meth)acryloxypropyl terminated polydimethylsiloxane (MPDMS). In another embodiment, the (meth)acryl-modified silicone is 2-hydroxy-3-methacryloxypropyl terminated polydimethylsiloxane (HMPDMS). Other reactive silicones are also contemplated.

In some embodiments, the acrylic portion of the silicone-modified acrylic emulsion may be formed from alkyl (meth)acrylates and vinyl monomers, such as but not limited to, methyl (meth)acrylate, ethyl (meth)acrylate, propyl (meth)acrylate, n-/i-/t-butyl (meth)acrylate, 2-ethylhexyl (meth)acrylate, lauryl (meth)acrylate, stearyl (meth)acrylate, hydroxyethyl (meth)acrylate, hydroxypropyl (meth)acrylate, hydroxybutyl (meth)acrylate, glycidyl methacrylate, 4-hydroxybutyl acrylate glycidyl ether, 2-(acetoacetoxy)ethyl methacrylate, lauryl methacrylate, stearyl methacrylate, cyclohexyl methacrylate, diacetone acrylamide, acrylamide, methacrylamide, methylol (meth)acrylamide, styrene, a-methyl styrene, vinyl toluene, vinyl acetate, vinyl propionate, allyl methacrylate, or combinations thereof. In some embodiments, the alkyl methacrylate polymers may be those prepared from a range of C12 to C22 alkyl methacrylates. Some preferred monomers include styrene, methyl methacrylate, methacrylic acid, hydroxyethyl acrylate, acetoacetoxyethyl methacrylate, butyl acrylate, butyl methacrylate, or combinations thereof. Others are also contemplated.

In some embodiments, the silicone-modified acrylic emulsion comprises about 1% to about 30% by weight silicone based on resin solids. In other embodiments, the silicone-modified acrylic emulsion can, for example, range from about 1% to about 25%, about 1% to about 20%, about 1% to about 15%, about 2% to about 30%, about 2% to about 25%, about 3% to about 25%, about 3% to about 23%, about 5% to about 25%, about 5% to about 20%, about 7% to about 25%, about 10% to about 25%, about 15% to about 25%, about 10% to about 20%, about 5% to about 15%, about 10% to about 15%, and about 5% about 15%, and about 15% to about 20% by weight silicone based on resin solids.

In some embodiments, the silicone-modified acrylic emulsion has a Tg of about −60° C. to about 40° C. In other embodiments, the silicone-modified acrylic emulsion can, for example, range from a Tg of about −60° C. to about 35° C., from a Tg of about −60° C. to about 30° C., from a Tg of about −60° C. to about 25° C., from a Tg of about −60° C. to about 20° C., from a Tg of about −55° C. to about 40° C., from a Tg of about −55° C. to about 35° C., from a Tg of about −55° C. to about 30° C., from a Tg of about −55° C. to about 25° C., from a Tg of about −55° C. to about 20° C., from a Tg of about −50° C. to about 40° C., from a Tg of about −50° C. to about 35° C., from a Tg of about −50° C. to about 30° C., and from a Tg of about −50° C. to about 25° C. In many embodiments, the silicone-modified acrylic emulsion can, for example, range from a Tg of about −50° C. to about 20° C., from a Tg of about −50° C. to about 10° C., from a Tg of about −50° C. to about 0° C., from a Tg of about −45° C. to about 20° C., from a Tg of about −45° C. to about 10° C., from a Tg of about −45° C. to about 0° C., from a Tg of about −40° C. to about 20° C., from a Tg of about −40° C. to about 10° C., from a Tg of about −40° C. to about 0° C., from a Tg of about −35° C. to about 20° C., from a Tg of about −35° C. to about 10° C., from a Tg of about −35° C. to about 0° C., from a Tg of about-30° C. to about 20° C., from a Tg of about −30° C. to about 10° C., from a Tg of about −30° C. to about 0° C., from a Tg of about −25° C. to about 20° C., from a Tg of about −25° C. to about 10° C., from a Tg of about −25° C. to about 0° C., from a Tg of about −20° C. to about 20° C., from a Tg of about −20° C. to about 10° C., from a Tg of about −20° C. to about 0° C., from a Tg of about −15° C. to about 20° C., from a Tg of about −15° C. to about 10° C., from a Tg of about −15° C. to about 0° C., from a Tg of about −10° C. to about 20° C., from a Tg of about −10° C. to about 10° C., and from a Tg of about −10° C. to about 0° C. Other Tg ranges are also contemplated.

In many embodiments, the silicone of the silicone-modified acrylic emulsion has a number average molecular weight (Mn) of about 600 to about 20,000. The number average molecular weight (Mn) may be measured by NMR or GPC referencing ASTM D5296. In other embodiments, Mn of the silicone-modified acrylic emulsion can, for example, range from about 700 to 20,000, from about 800 to 20,000, from about 800 to 15,000, 900 to 20,000, from about 900 to 20,000, from about 900 to 15,000, from about 900 to 12,000, from about 1000 to about 20,000, from about 1000 to about 15,000, from about 2,000 to about 20,000, from about 2,000 to about 18,000, from about 2,000 to about 15,000, from about 2,000 to about 12,000, from about 2,000 to about 10,000, from about 3,000 to about 20,000, from about 3,000 to about 18,000, from about 3,000 to about 15,000, from about 3,000 to about 12,000, from about 4,000 to about 20,000, from about 4,000 to about 18,000, from about 4,000 to about 15,000, from about 4,000 to about 12,000, from about 5000 to about 20,000, from about 5000 to about 15,000, from about 3000 to about 20,000, from about 3000 to about 15,000, from about 3000 to about 10,000, from about 3000 to about 8000, from about 4000 to 12,000, from about 8000 to about 20,000, from about 8000 to about 15,000, from about 10,000 to about 20,000, from about 10,000 to about 15,000, and from about 5,000 to about 10,000. Other molecular weight ranges are also contemplated. Further, in one embodiment, the silicone of the silicone-modified acrylic emulsion has a number average molecular weight (Mn) of about 900. In another embodiment, the silicone of the silicone-modified acrylic emulsion has a number average molecular weight (Mn) of about 2300. In yet another embodiment, the silicone of the silicone-modified acrylic emulsion has a number average molecular weight (Mn) of about 4600. In one embodiment, the silicone of the silicone-modified acrylic emulsion has a number average molecular weight (Mn) of about 5,000. Other Mn values are also contemplated.

In many embodiments, the silicone-modified acrylic emulsion has an acid value of about 10 mg KOH/g to about 30 mg KOH/g based on solid. Acid value as described herein may be measured according to ASTM D1639. In other embodiments, acid value of the silicone-modified acrylic emulsion can, for example, range from about 10 mg KOH/g to about 25 mg KOH/g, from about 10 mg KOH/g to about 20 mg KOH/g, from about 12 mg KOH/g to about 30 mg KOH/g, from about 12 mg KOH/g to about 25 mg KOH/g, from about 12 mg KOH/g to about 20 mg KOH/g, from about 12 mg KOH/g to about 15 mg KOH/g, from about 15 mg KOH/g to about 30 mg KOH/g, from about 15 mg KOH/g to about 25 mg KOH/g, from about 15 mg KOH/g to about 20 mg KOH/g, and from about 15 mg KOH/g to about 18 mg KOH/g, from about 18 mg KOH/g to about 25 mg KOH/g, from about 18 mg KOH/g to about 25 mg KOH/g, from about 19 mg KOH/g to about 24 mg KOH/g, from about 20 mg KOH/g to about 24 mg KOH/g, and from about 21 mg KOH/g to about 23 mg KOH/g. Other ranges are also contemplated.

The silicone-modified acrylic may include neutralizing agents. Examples of the neutralizing agents may include but are not limited to alkali metal hydroxides, such as sodium hydroxide, potassium hydroxide, or lithium hydroxide, ammonia, and amines. Suitable amines may include primary, secondary, and tertiary amines. Combinations of such primary, secondary, and tertiary amines may also be used. Suitable primary amines are, for example, isopropyl amine, butyl amine, ethanol amine, 3-amino-1-propanol, 1-amino-2-propanol, 2-amino-2-methyl-1-propanol, 2-amino-2-methyl-1,3-propane diol, or combinations thereof. Secondary amines that can be used are, for example, morpholine, diethyl amine, dibutyl amine, N-methyl ethanol amine, diethanol amine, diisopropanol amine, or combinations thereof. Examples of suitable tertiary amines include trimethyl amine, triethyl amine, triisopropyl amine, triisopropanol amine, N,N-dimethyl ethanol amine, dimethyl isopropyl amine, N,N-diethyl ethanol amine, 1-dimethyl amino-2-propanol, 3-dimethyl amino-1-propanol, 2-dimethyl amino-2-methyl-1-propanol, N-methyl diethanol amine, N-ethyl diethanol amine, N-butyl diethanol amine, N-ethyl morpholine, or combinations thereof. In some embodiments, tertiary amines may be preferred.

In many embodiments, at least one amine of the silicone-modified acrylic emulsion has a degree of neutralization ranging from about 60% to about 110%. In many embodiments, the amine may be at least one tertiary amine. In some embodiments, the at least one amine is trimethylamine, triethylamine, dimethylethanolamine, or combinations thereof. In some embodiments, at least one amine of the silicone-modified acrylic emulsion having a degree of neutralization can, for example, range from about 60% to about 100%, about 60% to about 90%, about 65% to about 110%, from about 65% to about 100%, from about 65% to about 90%, from about 65% to about 85%, from about 65% to about 80%, about 70% to about 110%, about 70% to about 100%, from about 70% to about 90%, from about 70% to about 85%, from about 70% to about 80%, about 75% to about 110%, about 75% to about 100%, from about 75% to about 90%, from about 75% to about 85%, from about 75% to about 80%, about 80% to about 110%, about 80% to about 100%, from about 80% to about 90%, and from about 85% to about 90%. In some embodiments, other amines such as primary amines and secondary amines are also contemplated. In some embodiments, the amine of the silicone-modified acrylic emulsion may also be a combination of different amines.

In some embodiments, the silicone-modified acrylic emulsion further comprises about 0.5% to about 10% by weight of at least one hydroxyl functional solvent. At least one hydroxyl functional solvent may include water-soluble mono- or polyhydric alcohols. At least one hydroxyl functional solvent may include, but is not limited to, alcohols, glycols, glycol mono ethers, or combinations thereof. Suitable alcohols may include but are not limited to ethanol, isopropanol, 2-butanol, tertiary butanol, diacetone alcohol, hexanol, benzyl alcohol, or combinations thereof. Other suitable alcohols may include hexyl glycol, butoxyethanol, 1-methoxy-propanol-2, 1-ethoxy-propanol-2, 1-propoxy-propanol-2, 1-butoxy-propanol-2, 2-methoxybutanol, 1-isobutoxy-propanol-2, dipropylene glycol monomethyl ether, diacetone alcohol, methanol, ethanol, propanol, isopropanol, butanol, 2-butanol, pentanol, hexanol, benzyl alcohol, or combinations thereof. Suitable glycols may include but are not limited to ethylene glycol, propylene glycol, 1,4-butanediol, 1,3-butanediol, 2,3-butanediol, 1,2-butanediol, 1,5-pentanediol, 1,4-pentanediol, 2,4-pentanediol, 3-methylpentane-1,5-diol, 3-methyl-4,5-pentanediol, diethylene glycol, propylene glycol, dipropylene glycol, dimethyl dipropylene glycol, triethylene glycol, isomeric butane diols, the polyethylene oxide glycols or polypropylene oxide glycols, 1,1,1-trimethylol propane, 1,2,3-trimethylol propane, pentaerythritol, glycerol, glycerol, diglycerol, and the like, or combinations thereof. Suitable polyalcohols may also include polycaprolactone polyols such as polycaprolactone triols and tetraols. Suitable glycol mono ethers may include ethylene glycol monobutyl ether, and propylene glycol methylether; and mixed ether acetates such as propylene glycol methylether acetate, diethylene glycol monobutyl ether acetate, and the like. Other hydroxyl functional solvents may include but not limited to methyl ether of diacetone alcohol, ethyl acetate, butyl acetate, ethyl glycol acetate, butyl glycol acetate, 1-methoxy-2-propyl acetate, butyl propionate, ethoxy ethyl propionate, toluene, xylene; methylethyl ketone, methyl isobutyl ketone, methyl amyl ketone, ethyl amyl ketone, dioxolane, N-methyl-2-pyrrolidone, dimethyl carbonate, propylene carbonate, butyrolactone, caprolactone, or combinations thereof.

In many embodiments, the silicone-modified acrylic emulsion consists essentially of water, being an aqueous composition. In some embodiments, about 20 wt. % of liquid content of the silicone-modified acrylic emulsion may be an organic solvent.

In some embodiments, at least one hydroxyl functional solvent may be used to control the viscosity of the silicone-modified acrylic emulsion. In some embodiments, at least one hydroxyl functional solvent may be used for preparing a silicone-modified acrylic as a secondary emulsion. In other embodiments, at least one hydroxyl functional solvent of the silicone-modified acrylic emulsion can, for example, range from about 0.5% to about 10% by weight, from about 0.5% to about 9% by weight, from about 0.5% to about 8% by weight, from about 1.0% to about 10% by weight, from about 1% to about 9% by weight, from about 1% to about 7% by weight, from about 2% to about 10% by weight, from about 2% to about 9% by weight, from about 2% to about 7% by weight, from about 3% to about 10% by weight, from about 3% to about 8% by weight, from about 4% to about 10% by weight, from about 4% to about 8% by weight, and from about 5% to about 9% by weight. Other ranges are also contemplated.

In many embodiments, an addition of a surfactant is minimized for the silicone-modified acrylic emulsion. In some embodiments, the silicone-modified acrylic emulsion contains substantially no surfactants. In other embodiments, the silicone-modified acrylic emulsion contains no surfactants. In yet another embodiment, any surfactants added to the silicone-modified acrylic emulsion is minimized. In many embodiments, the silicone-modified acrylic emulsion comprises less than 2.0% surfactants by weight. In other embodiments, the silicone-modified acrylic emulsion can, for example comprise less than 1.8% surfactants by weight, less than 1.5% surfactants by weight, less than 1.3% surfactants by weight, less than 1.0% surfactants by weight, less than 0.8% surfactants by weight, less than 0.7% surfactants by weight, less than 0.5% surfactants by weight, less than 0.3% surfactants by weight, less than 0.2% surfactants by weight, less than 0.1% surfactants by weight, and less than 0.05% surfactants by weight. Lower amounts of surfactant in the silicone-modified acrylic emulsion are also contemplated.

In many embodiments, the water-borne binder described herein may have a hydroxyl equivalent weight (OH EW) of the modified acrylic emulsion of about 400 g solid/mol or less. In other embodiments, the hydroxyl equivalent weight (OH EW) of the silicone-modified acrylic emulsion can, for example, be about 550 g solid/mol or less, about 525 g solid/mol or less, about 500 g solid/mol or less, about 450 g solid/mol or less, about 425 g solid/mol or less, about 400 g solid/mol or less, about 375 g solid/mol or less, about 350 g solid/mol or less, about 325 g solid/mol or less, about 300 g solid/mol or less, about 295 g solid/mol, about 290 g solid/mol or less, about 280 g solid/mol or less, about 270 g solid/mol or less, about 260 g solid/mol or less, about 250 g solid/mol or less, about 240 g solid/mol or less, about 230 g solid/mol or less, about 220 g solid/mol or less, about 210 g solid/mol or less, and about 200 g solid/mol or less. Lower values than 200 g solid/mol are also contemplated.

Additionally, the waterborne polymer system described herein may further comprise at least one co-binder. In some embodiments, at least one co-binder is polyurethane dispersion, water-based polyester, water-based acrylic, or combinations thereof. Other co-binders are also contemplated. Additionally, at least one additive and/or at least one pigment may be added to the waterborne polymer system described herein.

### Method of Preparing the Water Based Binder

Also disclosed is a method of preparing the waterborne polymer system disclosed herein. The waterborne polymer system comprises: 1) a silicone-modified acrylic emulsion comprising about 1% to about 30% by weight silicone based on resin solids, wherein the silicone-modified acrylic emulsion has a Tg of about −50° C. to about 20° C.; and 2) at least one hydroxyl functional acrylic monomer. The method of preparing the waterborne polymer system described herein may provide a silicone-modified acrylic emulsion that has a hydroxyl equivalent weight (OH EW) of about 400 g solid/mol or less.

Waterborne Coating Made from Waterborne Polymer System

Additionally, a waterborne coating may comprise the waterborne polymer system described herein, wherein the waterborne polymer system comprises: 1) a silicone-modified acrylic emulsion comprising about 1% to about 30% by weight silicone based on resin solids, wherein the silicone-modified acrylic emulsion has a Tg of about −50° C. to about 20° C.; and 2) at least one hydroxyl functional acrylic monomer. The method of preparing the waterborne polymer system described herein may provide a silicone-modified acrylic emulsion that has hydroxyl equivalent weight (OH EW) of about 400 g solid/mol or less. In many embodiments, the waterborne coating further comprises at least one thickener, defoamer, surfactant, dispersant, matting agent, solvent, antimicrobial agent, pigment, hardener, pH adjuster, or combinations thereof. Other additives are also contemplated.

In some embodiments, the waterborne coating with the waterborne polymer system described herein further comprises at least one secondary binder. In some embodiments, the secondary binder is an acrylic emulsion, a polyurethane dispersion, a water-reducible polyester polyol, or combinations thereof.

Further, the waterborne polymer system described herein, either with or without the co-binder(s), second binder(s), additive(s), and pigment(s) described above, may be one component of a two-component system. In the two-component system, the second component may comprise at least one isocyanate such that a polyurethane is formed when the isocyanate is combined with the waterborne polymer system described herein. In many embodiments, a water-based coating formed from the waterborne polymer system described herein and at least one isocyanate has an NCO/OH ratio (isocyanate index) ranging from 1:1 to 4:1. In other embodiments, the water-based coating has an NCO/OH ratio (isocyanate index) can, for example, range from 1:1 to 3.5:1, from 1:1 to 3:1, from 1:1 to 2.5:1, from 1:1 to 2:1, and from 1:1 to 1.5:1. Other ratios are also contemplated.

In some embodiments, the waterborne coating with the waterborne polymer system described herein has a 60-degree gloss measured by ASTM D323 that is no more than 10. The gloss can, for example, be no more than 9, no more than 8, no more than 7, no more than 6, no more than 5, no more than 4, no more than 3, no more than 2, and no more than 1. Lower values of the 60-degree gloss are also contemplated.

In many embodiments, the waterborne coating with the waterborne polymer system described herein has a Volatile Organic Compound (VOC) as measured by ASTM D3960 of less than 4.2 lb/gallon (about 500 g/l). In other embodiments, the waterborne coating with the waterborne polymer system described herein has a Volatile Organic Compound (VOC) as measured by ASTM D3960 of less than 2.8 lb/gallon (about 330 g/l). In some embodiments, the waterborne coating with the waterborne polymer system described herein has a Volatile Organic Compound (VOC) as measured by ASTM D3960 of less than 2.1 lb/gallon (about 250 g/L). The VOC can, for example, be less than 1.5 lb/gallon (about 175 g/l), less than 1.25 lb/gallon (about 150 g/l), less than 1.1 lb/gallon (about 130 g/l), less than 1.0 lb/gallon (about 120 g/l), less than 0.75 lb/gallon (about 90 g/l), less than 0.5 lb/gallon (about 60 g/l), less than 0.4 lb/gallon (about 50 g/l), less than 0.3 lb/gallon (about 35 g/l), less than 0.2 lb/gallon (about 25 g/l), less than 0.1 lb/gallon (about 12 g/l), or less than 0.05 lb/gallon (about 5 g/l). Lower VOC values are also contemplated. In one embodiment, the waterborne coating with the waterborne polymer system described herein has substantially no volatile organic compounds (VOC).

In some embodiments, the waterborne coating comprising the waterborne polymer system described herein has the dry film thickness (DFT) as measured by cross section microscopy of 0.8 to 3.0 mils. The dry film thickness can, for example, range from 0.9 to 2.0 mils, from 1.0 to 1.3 mils, from 1.2 to 2.4 mils, from 1.2 to 2.2 mils, from 1.3 to 2.2 mils, from 1.4 to 2.4 mils, from 1.4 to 2.2 mils, from 1.4 to 2.0 mils, from 1.5 to 2.4 mils, and from 1.5 to 2.2 mils. Other ranges are also contemplated. Further, the waterborne coating comprising the waterborne polymer system described herein has the dry film thickness (DFT) as measured by cross section microscopy is about 1 μm to about 51 μm. The dry film thickness can, for example, range from about 1 μm to about 50 μm, about 1 μm to about 45 μm, about 1 μm to about 40 μm, about 1 μm to about 35 μm, about 1 μm to about 30 μm, about 3 μm to about 51 μm, about 3 μm to about 50 μm, about 3 μm to about 45 μm, about 3 μm to about 40 μm, about 3 μm to about 35 μm, about 5 μm to about 50 μm, about 5 μm to about 45 μm, about 5 μm to about 40 μm, about 5 μm to about 35 μm, about 5 μm to about 30 μm, about 10 μm to about 50 μm, about 10 μm to about 45 μm, about 10 μm to about 40 μm, about 10 μm to about 35 μm, about 10 μm to about 30 μm, about 15 μm to about 50 μm, about 15 μm to about 45 μm, about 15 μm to about 40 μm, about 15 μm to about 35 μm, about 15 μm to about 30 μm, about 20 μm to about 50 μm, about 20 μm to about 45 μm, about 20 μm to about 40 μm, about 20 μm to about 35 μm, about 20 μm to about 30 μm, about 25 μm to about 50 μm, about 25 μm to about 45 μm, about 25 μm to about 40 μm, about 25 μm to about 35 μm, about 20 μm to about 30 μm, about 30 μm to about 50 μm, about 30 μm to about 45 μm, and about 30 μm to about 40 μm.

The waterborne coating composition described herein may show particular utility as clear coats, base coats, pigmented top coats, primers, and other coatings. The waterborne coating composition described herein is particularly suitable in the preparation of substrates, including but not limited to metal, plastics, wood, ceramics, cement, composites, or combinations thereof. The waterborne coating composition described herein may show particular utility as a monocoat, basecoat, primer, and clear coat in the Automotive Coatings market for vehicles such as automobiles, trains, trucks, buses, and airplanes. In particular, this coating can be applied over various plastic substrates including but not limited to polypropylene, polyamide, polyurethane, polyethylene, polyvinylchloride, polystyrene, Acrylonitrile Butadiene Styrene (ABS), acrylonitrile styrene acrylate (ASA), polycarbonate, polyoxymethylene, acrylic, polybutyleneterephthalate, polyethyleneterephthalate, or combinations thereof, in the Automotive Interior OEM market. In one embodiment, such as in the automotive OEM and refinish industry, in particular the body shop, the waterborne coating composition described herein may be used to repair automobiles and transportation vehicles, and in finishing large transportation vehicles such as trains, trucks, buses, and airplanes.

In many embodiments, the waterborne coating comprising the waterborne polymer system described herein has improved scratch resistance over conventional coatings. In many other embodiments, the waterborne coating comprising the waterborne polymer system described herein has improved abrasion resistance over conventional coatings. In some embodiments, the abrasion testing is linear abrasion testing. In many other embodiments, the waterborne coating comprising the waterborne polymer system described herein has improved adhesion over conventional coatings.

In many embodiments, the waterborne coating comprising the waterborne polymer system described herein has improved chemical resistance over conventional coatings. Chemical resistance may include but are not limited to such chemicals as solvents, oils, suntan lotions, insect repellents, and others. In many embodiments, the waterborne coating comprising the waterborne polymer system described herein has improved surface slip over conventional coatings. In many embodiments, the waterborne coating comprising the waterborne polymer system described herein has an improved surface over conventional coatings which may have surface defects like craters. In many embodiments, the waterborne coating comprising the waterborne polymer system described herein is recoatable.

### At Least One Secondary Binder of the Waterborne Polymer System

The resin or polymer system described above is suited for waterborne, two-component coatings compositions having a low gloss value and low film thickness. The first component of the polymer system comprises the waterborne polymer system described above comprising a silicone-modified acrylic emulsion and at least one hydroxyl functional acrylic monomer. The first component of the two-component composition may be a polymer component including any of the features of the above-described waterborne polymer systems described herein, either by themselves or blended with other polymer systems such as waterborne polyester polyols, acrylic polyols, and/or polyurethane dispersions. Further, at least one secondary binder may comprise at least one acrylic emulsion, at least one water-reducible polyester polyol, at least one polyurethane dispersion, or combinations thereof. Both first component of the polymer system and the second component of the polymer system used in the two-component coating composition may also include but is not limited to solvents, pigments, extenders, flatteners, and other additives as desired for the application, performance, and low gloss appearance.

In the two-component of the polymer system used in the coating composition, the second component may comprise an isocyanate functional material suitable for crosslinking the one or more water-based polyols, such as a water-based silicone acrylic, a polyurethane dispersion (PUD), a water-base polyester, and a water-based acrylic. The isocyanate functional material may be selected from mono-, di-, tri-, and poly-functional isocyanates. In many embodiments, free polyisocyanates may have an average NCO functionality of more than 2 or a range of 2.5 to 5. Further, the isocycanate functional material may be (cyclo) aliphatic, araliphatic or aromatic in nature. Representative isocyanates will have two or more isocyanate groups per molecule and may include the aliphatic compounds such as ethylene diisocyanate, trimethylene diisocyanate, tetramethylene diisocyanate, pentamethylene diisocyanate, hexamethylene diisocyanate, 1,2-propylene diisocyanate, 1,2-butylene diisocyanate, 2,3-butylene diisocyanate, 1,3-butylene diisocyanate, ethylidene diisocyanate and butylidene diisocyanate; the cycloalkylene compounds such as 3-isocyanatomethyl-3,5,5-trimethylcyclohexylisocyanate, and 1,3-cyclopentane diisocyanate, 1,3-cyclohexane diisocyanate, and 1,2-cyclohexane diisocyanate; the aromatic compounds such as m-phenylene diisocyanate, p-phenylene diisocyanate, 4,4′-diphenyl diisocyanate, 1,5-naphthalene diisocyanate and 1,4-naphthalene diisocyanate; the aliphatic-aromatic compounds such as 4,4′-diphenylene methane diisocyanate, 2,4- or 2,6-toluene diisocyanate, or mixtures thereof, 4,4′-toluidine diisocyanate, and 1,4-xylylene diisocyanate; the nuclear substituted aromatic compounds such as dianisidine diisocyanate, 4,4′-diphenylether diisocyanate and chlorodiphenylene diisocyanate; the triisocyanates such as triphenyl methane-4,4′,4″-triisocyanate, 1,3,5-triisocyanate benzene and 2,4,6-triisocyanate toluene; and the tetraisocyanates such as 4,4′-diphenyl-dimethyl methane-2,2′-5,5′-tetraisocyanate; the polymerized polyisocyanates such as toluene diisocyanate dimers and trimers, and other various polyisocyanates containing biuret, urethane, and/or allophanate linkages. Further, the isocyanates may be hydrophobic organic polyisocyanates including but not limited to: 1,6-diisocyanatohexane, isophorone diisocyanate, diphenyl methane-diisocyanate, 4,4′-bis(isocyanatocyclohexyl) methane, 1,4-diisocyanatobutane, 1,5-diisocyanato-2,2-dimethyl pentane, 2,2,4-trimethyl-1,6-diisocyanatohexane, 1,10-diisocyanatodecane, 4,4-diisocyanato-cyclohexane, 2,4-hexahydrotoluene diisocyanate, 2,6-hexahydrotoluene diisocyanate, norbornane diisocyanate, 1,3-xylylene diisocyanate, 1,4-xylylene diisocyanate, 1-isocyanato-3-(isocyanato methyl)-1-methyl cyclohexane, m-α,α-α′,α′-tetramethyl xylylene diisocyanate, or combinations thereof. In some embodiments, the hydrophobic polyisocyanate may include biuret, urethane, uretdione, and isocyanurate derivatives of the above-mentioned compounds. Normally, these products are liquid at ambient temperature and commercially available in a wide range. Particularly preferred isocyanate curing agents are triisocyanates and adducts. Examples thereof are 1,8-diisocyanato-4-(isocyanatomethyl) octane, the adduct of 3 moles of toluene diisocyanate to 1 mole of trimethylol propane, the isocyanurate trimer of 1,6-diisocyanatohexane, the isocyanurate trimer of isophorone diisocyanate, the uretdione dimer of 1,6-diisocyanatohexane, the biuret trimer of 1,6-diisocyanatohexane, the adduct of 3 moles of m-α,α-α′,α′-tetramethyl xylene diisocyanate to 1 mole of trimethylol propane, and combinations thereof. Optionally, the isocyanate may comprise an organic hydrophilic polyisocyanate compound substituted with non-ionic groups, such as the above-mentioned C1-C4 alkoxy polyalkylene oxide groups. In some embodiments, 30 wt. % of non-ionic groups may be present on total solid polyisocyanate compound, i.e. organic hydrophobic and hydrophilic polyisocyanate. In other embodiments, 20 wt. % of non-ionic groups may be present on total solid polyisocyanate compound. In other embodiments, 15 wt. % of non-ionic groups may be present on total solid polyisocyanate compound. Combinations of mono-, di-, tri-, and multifunctional isocyanates are also contemplated. The isocyanates may be waterborne, solvent-borne, or a combination thereof.

The amount of isocyanate functional material used in the of the polymer system of the coating composition may be sufficient to provide an NCO:OH ratio of about 0.8:1 to about 4:1, wherein the OH represents the total moles of the hydroxyl groups in the resin systems. The ratio can, for example, be about 1:1 to about 4:1, about 1:1 to about 3:1, and about 1:1 to about 2:1. Other ratios are also contemplated. In some approaches, the isocyanate functional material may be packaged separately from the component including the above-described polymer systems and other optional components. The curing component, including the isocyanate functional material, may further include one or more catalysts, solvents, non-reactive (with the isocyanate) additives, and combinations thereof as needed for a particular application.

The isocyanate functional material may be mixed into the first component by any suitable technique. However, simply stirring is usually sufficient. Sometimes it may be useful to dilute the isocyanate functional material somewhat with an organic solvent like butyl acetate or 1-methoxy-2-propyl acetate to reduce the viscosity.

In many embodiments, the second component of the polymer system used in the two-part coating composition may include an amount of one or more catalysts that catalyze the isocyanate hydroxyl reaction. This catalyst may be provided in the polymer component of the composition. Examples of useful catalysts may include tertiary amines, such as triethylene diamine, N-methyl morpholine, N-ethyl morpholine, diethyl ethanolamine, 1-methyl-4-dimethylamino ethyl piperazine, 3-methoxy-N-dimethyl propyl amine, N-dimethyl-N-methyl isopropyl propylene diamine, N,N-diethyl-3-diethyl amino propylamine, N,N-dimethyl benzyl amine, dicyclohexylmethylamine, 2,4,6-tris dimethylaminomethylphenol, N,N-dimethyl cyclohexylamine, triethylamine, tri-n-butylamine, 1,8-diaza-bichloro [5,40]-undecene-7 N-methyl diethanolamine, N,N-dimethyl ethanolamine, N,N-diethyl cyclohexylamine, N,N,N′,N′-tetramethyl-ethylene diamine, 1,4-diaza-bicyclo-[2,2,2]-octane N-methyl-N′-dimethyl aminoethyl-piperazine, bis-(N,N-diethylaminoethyl)-adipate, N,N-diethylbenzylamine, pentamethyldiethylene triamine, N,N,N′,N′-tetramethyl-1,3-butanediamine, 1,2-dimethyl imidazole, 2-methylimidazole; tin compounds, such as stannous chloride, dibutyl tin di-2-ethyl hexoate, stannous octoate, dibutyl tin dilaurate, trimethyl tin hydroxide, dimethyl tin dichloride, dibutyl tin diacetate, dibutyl tin oxide, tributyl tin acetate, tetramethyl tin, dimethyl dioctyl tin, tin ethyl hexoate, tin laurate, dibutyl tin maleate, dioctyl tin diacetate; other metal organics, such as zinc octoate, phenyl mercuric propionate, lead octoate, lead naphthenate, copper naphthenate, or combinations thereof. Other tin additives are also contemplated.

In one approach, the catalyst of the second component of the of the polymer system used in the two-part coating composition is dibutyltin dilaurate. Useful amounts of catalyst will be about 0.01 to 5%, based on the total weight of the polymer described herein plus the polyisocyanate. The catalyst may be provided in whole or in part with the polymer component or in whole or in part with the curing component or may be disposed partly within both the polymer component and any hardener components as needed for a particular application. Pot life may be 4 to 12 hours, depending on the type and amount of catalyst(s).

Further, in some embodiments of the two-part of the polymer system used in the coating composition, the composition of the first component of the polymer system may include one or more solvents such as ketone, ester, alcohol, glycol ether, and glycol ether ester solvents. Exemplary, non-limiting examples of solvents that may be useful include propylene glycol-n-butyl ether, t-butanol, di-sec-butyl ether, n-butanol, butyl carbitol acetate, n-butyl acetate, t-butyl acetate, acetone, propylene glycol methyl ether acetate, propylene carbonate, 2-butoxyethanol, dipropylene glycol n-butyl ether, propylene glycol n-butyl ether and the like, or combinations thereof. Non-reactive (with the isocyanate) solvents can be used in the second isocyanate component. The total amount of solvent used in the composition may be selected to provide the coating with a suitable viscosity for the application method.

Additionally, the second component of the polymer system may also include other additives appropriate for the desired use or application, including non-reactive (with the isocyanate) additives. Non-reactive additives as used herein refer to a general category of components or other raw materials that may be added to the compositions herein to promote various properties. Examples include, but are not limited to, other polymers or polymer dispersions, surfactants, dispersants, defoamers, biocides, mildewcides, algaecides, thickeners, leveling agents, anti-settling agents, pH buffers, corrosion inhibitors, driers, anti-skinning agents, anti-cratering agents, anti-sag agents, heat stabilizers, UV absorbers/inhibitors, antioxidants, wetting agents, flatteners and other inert pigments (such as titanium dioxide, dyes, clay, amorphous and surface treated silica, calcium carbonate, and the like, and combinations thereof), flow agents, and the like, and various combinations thereof as needed for a particular application.

The resin or polymer systems described herein are particularly suited for two-component polymer systems that may be used in waterborne coatings compositions to provide thin dry films on various rigid and flexible plastic substrates, such as but not limited to, acrylonitrile butadiene styrene (ABS), polycarbonate (PC), ABS/PC blends, thermoplastic polyolefin (TPO), and polypropylene (PP). These coatings are intended to service performance coatings markets such as aerospace, automotive, general industry, protective and marine and wood coatings markets. This composition is configured to achieve a very low gloss of about 5 or less at very thin dry film thickness, about 3 mils or less. The resin or polymer systems described herein achieve performance properties such as excellent adhesion, chemical resistance, scratch resistance, abrasion resistance, surface slip, recoatability, and other weathering resistance testing. The coatings should also be free of surface defects like craters, picture framing, and foam.

Article with Waterborne Coating Made from Waterborne Polymer System

Also disclosed herein is an article comprising: 1) a substrate having at least one major surface; and 2) the waterborne coating described herein at least partially applied to the substrate, wherein the substrate comprises wood, metal, glass, plastic, paper, leather, fabric, ceramic, or any combination thereof. The waterborne coating may comprise the waterborne polymer system described herein. The waterborne polymer system comprises: 1) a silicone-modified acrylic emulsion comprising about 1% to about 30% by weight silicone based on resin solids, wherein the silicone-modified acrylic emulsion has a Tg of about −50° C. to about 20° C.; and 2) at least one hydroxyl functional acrylic monomer. The method of preparing the waterborne polymer system described herein may provide a hydroxyl equivalent weight (OH EW) of the silicone-modified acrylic emulsion is about 400 g solid/mol or less.

In many embodiments, the waterborne coating comprising the waterborne polymer system described herein has improved application properties over conventional coatings. Application may be spray, brush, roll, pad, or combinations thereof. Curing temperatures preferably are between 0° C. and 80° C., and more preferably between 10° C. and 60° C. Humidity conditions may range from 5% Relative Humidity to 95% Relative Humidity. Other application methods are also contemplated.

In some embodiments, at least one additional waterborne coating composition described herein may be applied to the waterborne coating composition. In another embodiment, at least one other coating layer that is different from the waterborne coating composition described herein may be at least partially applied to the waterborne coating composition.

### Resin Examples for Waterborne Polymer System

Resin Example 1 (Comparative): To a 5-litter reactor equipped with stirrer, thermocouple, condenser, monomer and nitrogen inlets, 111.6 grams of 2-butanol was charged and heated to 80° C. under agitation and nitrogen blanket. A mixture of 425.6 grams of butyl acrylate, 296.1 grams of 2-hydroxyethyl acrylate, 44.6 grams of 2-acrylamido-2-methylpropane sulfonic acid (as 50% in water), 606.8 grams of 2-butanol and 80.1 grams of DI water was fed to the reactor over four hours. Simultaneously, 44.6 grams of tert-amyl peroxy-2-ethylhexanoate was also fed over four hours to the reactor. After the solution was held for 30 minutes at 80° C., 3.0 grams of tert-amyl peroxy-2-ethylhexanoate was added. The solution was then held for another two hours. A dean stark trap, which was filled with DI water, was added between the reactor and condenser. The reaction solution was heated up to remove 2-butanol through azeotrope via the trap. The percent solid was adjusted with DI water before discharge. The product had a solid content of about 48.3% by weight, density of about 8.80 lb/gal, an OH equivalent weight of about 300 g/mol on solid, a Tg of about −20.0° C., an acid value of about 4.1 mg KOH/g solid, Mn about 2,572 and Mw about 5,020 by GPC.

Resin Example 2 (Comparative): To a 3-litter reactor equipped with stirrer, thermocouple, condenser, monomer and nitrogen inlets, 125.6 grams of propylene glycol methyl ether was charged and heated to 120° C. under agitation and nitrogen blanket. A mixture of 477.4 grams of butyl acrylate, 335.0 grams of 2-hydroxyethyl acrylate and 25.1 grams of glacial methacrylic acid was fed into the reactor over four hours. Simultaneously, 25.1 grams of tert-butyl peroxy-2-ethylhexanoate was also fed over four hours to the reactor. After the solution was held for 30 minutes at 120° C., a mixture of 3.4 grams of tert-butyl peroxy-2-ethylhexanoate and 8.4 grams of propylene glycol methyl ether was charged. The solution was then held for another two hours and cooled to 60° C. Then, 20.8 grams of triethylamine and 20.8 grams of DI water were slowly added to the reactor and mixed for 30 minutes before adding another 1000 grams of DI water. The dispersion was mixed for 60 minutes, cooled to 40° C. and discharge through a filter. The product had a solid content of about 40.1% by weight, density of about 8.75 lb/gal, an OH equivalent weight of about 295 g/mol on solid, pH of about 7.6, a Tg of about −12° C., an acid value of about 21.1 mg KOH/g solid, Mn about 4,851 and Mw about 12,540 by GPC.

Resin Example 3: To a 3-litter reactor equipped with stirrer, thermocouple, condenser, monomer and nitrogen inlets, 150.8 grams of propylene glycol methyl ether was charged and heated to 120° C. under agitation and nitrogen blanket. A mixture of 472.4 grams of butyl acrylate, 402.0 grams of 2-hydroxyethyl acrylate, 30.2 grams of glacial methacrylic acid and 100.5 grams of monomethacryloxypropyl terminated polydimethylsiloxane (Mw about 4,600) was fed into the reactor over four hours. Simultaneously, 30.2 grams of tert-butyl peroxy-2-ethylhexanoate was also fed over four hours to the reactor. After the solution was held for 30 minutes at 120° C., a mixture of 4.0 grams of tert-butyl peroxy-2-ethylhexanoate and 10.1 grams of propylene glycol methyl ether was charged. The solution was then held for another two hours and cooled to 50° C. Then, 30.2 grams of triethylamine and 1325.1 grams of DI water were slowly added to the reactor and mixed for 30 minutes before discharge through a filter. The product had a solid content of about 38.9% by weight, density of about 8.71 lb/gal, an OH equivalent weight of about 295 g/mol on solid, pH of about 7.6, a Tg of about −1.2° C., an acid value of about 20.4 mg KOH/g solid, Mn about 5,283 and Mw about 19,613 by GPC.

Resin Example 4: To a 5-litter reactor equipped with stirrer, thermocouple, condenser, monomer and nitrogen inlets, 126.7 grams of propylene glycol methyl ether was charged and heated to 100° C. under agitation and nitrogen blanket. A mixture of 529.1 grams of butyl acrylate, 247.9 grams of 2-hydroxyethyl acrylate, 25.3 grams of glacial methacrylic acid and 42.2 grams of methacryl-modified silicone fluid (monomethacryloxypropyl terminated polydimethylsiloxane with Mw about 2,000 or 2,300) was fed to the reactor over four hours. Simultaneously, 16.9 grams of tert-butyl peroxy-2-ethylhexanoate was also fed over four hours to the reactor. After the solution was held for 30 minutes at 100° C., a mixture of 3.4 grams of tert-butyl peroxy-2-ethylhexanoate and 8.4 grams of propylene glycol methyl ether was charged. The solution was then held for another two hours and cooled to 50° C. Then, 23.9 grams of triethylamine and 1113.0 grams of DI water were slowly added to the reactor and mixed for 30 minutes before discharge through a filter. The product had a solid content of about 30.6% by weight, density of about 8.53 lb/gal, an OH equivalent weight of about 400 g/mol on solid, pH of about 8.3, a Tg of about −10° C., an acid value of about 20 mg KOH/g solid, Mn about 12,224 and Mw about 43,246 by GPC.

### Paint Examples for Water Based Coatings

Paint Example 1 (Comparative Control): A coatings system was prepared by taking 60 g of Resin Example 1 and blending with 30 g DI water and the following cosolvent package: 1.5 g ethylene glycol monobutyl ether, 1.5 g DpNB glycol ether, 1 g propylene glycol monomethyl ether. The sample was mixed for 5 minutes. To reach the desired low gloss target, 5 g of a polymer-treated thermal silica was added to the system and mixed for 10 minutes using a cowless blade. The following additives were incorporated into the system to address foam, flow and leveling, and rheology properties: 1 g of defoamer, 1 g of substrate wetting additive, 0.5 g of non-silicone surfactant. The system was neutralized using 2.5 g of a 10% triethanolamine solution. The formula was mixed for an additional 10 minutes to complete the first component.

Paint Example 2 (Comparative Control): A coatings system was prepared by taking 60 g of Resin Example 2 and blending with 30 g DI water and the following cosolvent package: 1.5 g ethylene glycol monobutyl ether, 1.5 g DpNB glycol ether, 1 g propylene glycol monomethyl ether. The sample was mixed for 5 minutes. To reach the desired low gloss target, 5 g of a polymer-treated thermal silica was added to the system and mixed for 10 minutes using a cowless blade. The following additives were incorporated into the system to address foam, flow and leveling, and rheology properties: 1 g of defoamer, 1 g of substrate wetting additive, 0.5 g of non-silicone surfactant. The system was neutralized using 2.5 g of a 10% triethanolamine solution. The formula was mixed for an additional 10 minutes to complete the first component.

Paint Example 3: A coatings system was prepared by taking 60 g of Resin Example 3 and blending with 30 g DI water and the following cosolvent package: 1.5 g ethylene glycol monobutyl ether, 1.5 g DpNB glycol ether, 1 g propylene glycol monomethyl ether. The sample was mixed for 5 minutes. To reach the desired low gloss target, 5 g of polymer-treated thermal silica was added to the system and mixed for 10 minutes using a cowless blade. The following additives were incorporated into the system to address foam, flow and leveling, and rheology properties: 1 g of defoamer, 1 g of substrate wetting additive, 0.5 g of non-silicone surfactant. The system was neutralized using 2.5 g of a 10% triethanolamine (TEA) solution. The formula was mixed for an additional 10 minutes to complete the first component.

Paint Example 4: A coatings system was prepared by taking 60 g of Resin Example 4 and blending with 30 g DI water and the following cosolvent package: 1.5 g ethylene glycol monobutyl ether, 1.5 g DpNB glycol ether, 1 g propylene glycol monomethyl ether. The sample was mixed for 5 minutes. To reach the desired low gloss target, 5 g of silica was added to the system and mixed for 10 minutes using a cowels blade. The following additives were incorporated into the system to address foam, flow and leveling, and rheology properties: 1 g of defoamer, 1 g of substrate wetting additive, 0.5 g of non-silicone surfactant. The system was neutralized using 2.5 g of a 10% triethanolamine (TEA) solution. The formula was mixed for an additional 10 minutes to complete the first component.

Paint Examples 1, 2, 3 and 4 were each crosslinked with hydrophilic aliphatic hexamethylene diiosocyanate, at an NCO:OH index of 1.5:1, respectively. The two components were mixed for 3 minutes using a standard mixing blade before application. The paint for Examples 1, 2, 3, and 4 was applied over ABS substrate using HVLP spray equipment with the following parameters: gravity feed gun 4 mm gun tip, 50 psi at wall, 29 psi at gun, fan closed ¼ turn; fluid open all the way. All of the coatings were sprayed at 2 coats with a room temperature (approximately 25° C.) flash of 5-10 minutes (until noticeable gloss change) and a 30-minute bake at 180° F. The coating samples were then placed in control temp and humidity room for 7 days before testing was completed.

Performance testing for these paints included 60° gloss (as measured by ASTM D523), slip resistance (as measured by ASTM D2047), chemical resistance (using GMW14445 Sunscreen and Insect Repellant testing; and scratch and mar resistance (using GMW14698). GMW14445 GM ratings for Sunscreen and Insect Repellant are on a 1-4 scale as follows with a 2 rating as a pass: 1—no visual defect, 2—minor staining/swelling, 3—significant staining, swelling, or minor blistering, 4—complete blistering and wrinkling of coating, and a 2 is rated as a pass. GM14698 is run at 13N with a 1 mm tip. No penetration of surface or heavy mar with and without 10× magnification. For reporting purposes, the scale was converted to a 1-5 rating scale of the following: 1—Fail—complete coating penetration, 2—Fail—significant mar and/or surface penetration, 3—Fail—moderate mar and/or surface penetration, 4—Pass—minor mar, and 5—Pass—No visible line.

TABLE 1
Performance Testing Results

| | | | | GMW14445 | GMW14698 |
|---|---|---|---|---|---|
| | Dry film | 60 | Soft | Chemical | Scratch |
| Paint | thickness | degree | Feel | Resistance | and Mar |
| Example | (mil) | gloss | Rating | Rating | Resistance |
| Example 1 | 2 | 2 | Hardcoat | 3 (Fail) | 4 (Pass) |
| Example 2 | 2 | 2 | Hardcoat | 3 (Fail) | 3 (Fail- some |
| | | | | | peeled off) |
| Example 3 | 2 | 2 | Increased | 2 (Pass) | 5 (Pass- |
| | | | grip | | improved) |
| Example 4 | 2 | 2 | Increased | 2 (Pass) | 5 (Pass- |
| | | | grip | | improved) |

For the Paint Examples provided above, both Paint Examples 3 and 4 contain two different silicone-modified acrylic emulsions. Additionally, both Paint Examples 3 and 4 have shown increased slip, improved chemical resistance, and improved scratch and mar resistance over the Control Examples 1 and 2.

### EMBODIMENTS

The following embodiments are contemplated. All combinations of features and embodiments are contemplated.

Embodiment 1: A waterborne polymer system comprising: 1) a silicone-modified acrylic emulsion comprising: about 1% to about 30% by weight silicone based on resin solids; and at least one hydroxyl functional acrylic monomer; and 2) at least one secondary binder comprising at least one acrylic emulsion, at least one water-reducible polyester polyol, at least one polyurethane dispersion, or combinations thereof; wherein the silicone-modified acrylic emulsion has a Tg of about −50° C. to about 20° C.; and wherein a hydroxyl equivalent weight (OH EW) of the silicone-modified acrylic emulsion is about 400 g solid/mol or less.

Embodiment 2: An embodiment of Embodiment 1, wherein the silicone-modified acrylic emulsion comprises about 1% about 15% by weight silicone based on resin solids.

Embodiment 3: An embodiment of any of Embodiments 1-2, wherein the silicone of the silicone-modified acrylic emulsion is a (meth)acryl-modified silicone fluid.

Embodiment 4: An embodiment of Embodiment 3, wherein the (meth)acryl-modified silicone fluid is a mono(meth)acryloxypropyl terminated polydimethylsiloxane.

Embodiment 5: An embodiment of any of Embodiments 1-4, wherein the silicone has a number average molecular weight (Mn) of about 900 to about 20,000.

Embodiment 6: An embodiment of any of Embodiments 1-4, wherein the silicone has a number average molecular weight (Mn) of about 2,000 to about 12,000.

Embodiment 7: An embodiment of any of Embodiments 1-6, wherein the silicone-modified acrylic emulsion has an acid value of about 10 mg KOH/g to about 30 mg KOH/g.

Embodiment 8: An embodiment of any of Embodiments 1-7, wherein the silicone-modified acrylic emulsion further comprises about 0.5% to about 10% by weight of at least one hydroxyl functional solvent.

Embodiment 9: An embodiment of any of Embodiments 1-8, where the silicone-modified acrylic emulsion comprises substantially no surfactant.

Embodiment 10: An embodiment of any of Embodiments 1-9, wherein at least one amine of the silicone-modified acrylic emulsion has a degree of neutralization ranging from about 60% to about 90%.

Embodiment 11: An embodiment of any of Embodiments 1-10, wherein the silicone-modified acrylic emulsion comprises at least one tertiary amine.

Embodiment 12: An embodiment of any of Embodiments 1-11, wherein the silicone-modified acrylic emulsion has a Tg of about −40° C. to about 0° C.

Embodiment 13: A method of preparing the waterborne polymer system of any of Embodiments 1-12.

Embodiment 14: A waterborne coating comprising the waterborne polymer system of any of Embodiments 1-12.

Embodiment 15: An embodiment of Embodiment 14 further comprising: at least one thickener, defoamer, surfactant, dispersant, matting agent, solvent, antimicrobial agent, pigment, hardener, or combinations thereof.

Embodiment 16: An embodiment of any of Embodiments 14-15, wherein the 60-degree gloss measured by ASTM D323 is no more than 10.

Embodiment 17: An embodiment of any of Embodiments 14-16, wherein the dry film thickness (DFT) as measured by cross section microscopy is 1.0 to 3.0 mils.

Embodiment 18: An embodiment of any of Embodiments 14-16, wherein the dry film thickness (DFT) as measured by cross section microscopy is about 1 μm to about 51 μm.

Embodiment 19: An article comprising: 1) a substrate having at least one major surface; and 2) the waterborne coating of any of Embodiments 14-18 at least partially disposed on the substrate; wherein the substrate comprises wood, metal, glass, plastic, paper, leather, fabric, ceramic, or any combination thereof

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A waterborne polymer system comprising:
a silicone-modified acrylic emulsion comprising:
about 1% to about 30% by weight silicone based on resin solids; and
at least one hydroxyl functional acrylic monomer; and
at least one secondary binder comprising at least one acrylic emulsion, at least one water-reducible polyester polyol, at least one polyurethane dispersion, or combinations thereof;
wherein the silicone-modified acrylic emulsion has a Tg of about −50° C. to about 20° C.; and
wherein a hydroxyl equivalent weight (OH EW) of the silicone-modified acrylic emulsion is about 400 g solid/mol or less.

2. The waterborne polymer system of claim 1, wherein the silicone-modified acrylic emulsion comprises about 1% about 15% by weight silicone based on resin solids.

3. The waterborne polymer system of claim 1, wherein the silicone of the silicone-modified acrylic emulsion is a (meth)acryl-modified silicone fluid.

4. The waterborne polymer system of claim 3, wherein the (meth)acryl-modified silicone fluid is a mono(meth)acryloxypropyl terminated polydimethylsiloxane.

5. The waterborne polymer system of claim 1, wherein the silicone has a number average molecular weight (Mn) of about 900 to about 20,000.

6. The waterborne polymer system of claim 1, wherein the silicone has a number average molecular weight (Mn) of about 2,000 to about 12,000.

7. The waterborne polymer system of claim 1, wherein the silicone-modified acrylic emulsion has an acid value of about 10 mg KOH/g to about 30 mg KOH/g.

8. The waterborne polymer system of claim 1, wherein the silicone-modified acrylic emulsion further comprises about 0.5% to about 10% by weight of at least one hydroxyl functional solvent.

9. The waterborne polymer system of claim 1, where the silicone-modified acrylic emulsion comprises substantially no surfactant.

10. The waterborne polymer system of claim 1, wherein the silicone-modified acrylic emulsion has a degree of neutralization ranging from about 60% to about 90%.

11. The waterborne polymer system of claim 1, wherein the silicone-modified acrylic emulsion comprises at least one tertiary amine.

12. The waterborne polymer system of claim 1, wherein the silicone-modified acrylic emulsion has a Tg of about −40° C. to about 0° C.

13. A method of preparing the waterborne polymer system of claim 1.

14. A waterborne coating comprising the waterborne polymer system of claim 1.

15. The waterborne coating of claim 14 further comprising:
at least one thickener, defoamer, surfactant, dispersant, matting agent, solvent, antimicrobial agent, pigment, hardener, or combinations thereof.

16. The waterborne coating of claim 14, wherein the 60-degree gloss measured by ASTM D323 is no more than 10.

17. The waterborne coating of claim 14, wherein the dry film thickness (DFT) as measured by cross section microscopy is about 1.0 to about 3.0 mils.

18. The waterborne coating of claim 14, wherein the dry film thickness (DFT) as measured by cross section microscopy is about 1 μm to about 51 μm.

19. An article comprising:
a substrate having at least one major surface; and
the waterborne coating of claim 14 at least partially disposed on the substrate;
wherein the substrate comprises wood, metal, glass, plastic, paper, leather, fabric, ceramic, or any combination thereof.
